(19) United States
(12) Patent Application Publication
(10) Pub. No.: US 2005/0229863 A1
(43) Pub. Date: Oct. 20, 2005

(54) Artificial reef

(76) Inventors: Larry Harper, Clinton, KY (US); Steve Larkin, Columbus, KY (US)

Correspondence Address: FRASER MARTIN BUCHANAN MILLER LLC, 132C WEST SECOND STREET, PERRYSBURG, OH, 43551-1401, US

(21) Appl. No.: 11/154,859

(22) Filed: Jun. 16, 2005

Related U.S. Application Data
(63) Continuation-in-part of application No. 10/765,225, filed on Jan. 26, 2004.
(60) Provisional application No. 60/442,972, filed on Jan. 27, 2003.

(51) Int. Cl. A01K 61/00

(52) U.S. Cl. 119/221

(57) ABSTRACT

An artificial reef for attracting fish comprises a main body of spherical shape provided with a plurality of apertures, a plurality of hollow inserts snuggly disposed in each of the apertures of said main body, said hollow inserts extending radially outwardly from the outer surface of said main body a distance greater than the depth of the apertures, and a plurality of elongate members extending radially outwardly from said main body, said elongate members including a proximal end and a distal end, the proximal ends of said elongate members received within respective ones of said hollow inserts.

### CROSS-REFERENCE TO RELATED APPLICATIONS

This application is a continuation-in-part of U.S. utility application Ser. No. 10/765,225 filed Jan. 26, 2004, now abandoned, which claimed the benefit of U.S. provisional patent application Ser. No. 60/442,972 filed Jan. 27, 2003.

### FIELD OF THE INVENTION

The present invention relates to a structure for attracting fish and more particularly to an artificial reef and a method of making and using same.

### BACKGROUND OF THE INVENTION

Considerable research has been conducted regarding methods and structures for attracting both sport and commercial fish in bodies of water such as lakes and streams in the United States as well as other parts of the world.

It has been found that the provision of artificial reefs has successfully caused the congregation of fish in many areas of the world. Fish naturally seek areas where food may be available and shelter is provided from predators. Normally, ocean reefs, seaweed beds, grassy areas, and rocky areas are exemplary of locations which afford a supply of food and afford some degree of protection from predators. Manifestly, such areas are not always available. Accordingly, it has been found that artificial reefs can be utilized in certain areas to provide attraction for fish to congregate and breed. Different types of materials have been used to form artificial reefs with varying success. Cost and attendant aesthetics are matters which must be considered.

An object of the present invention is to produce an artificial fish attracting reef which can be economically manufactured.

Another object of the invention is to produce an artificial reef from components formed of a lightweight material which may be readily and easily transported to a selected site and assembled on site without the requirement of special skills or expensive tools.

Yet another object of the invention is to produce an artificial reef for attracting fish which is formed of an inert material having a long duty cycle.

### SUMMARY OF THE INVENTION

Accordant with the present invention, the above objects may be achieved by an artificial reef for attracting fish comprising a main body of spherical shape provided with a plurality of apertures, a plurality of hollow inserts snuggly disposed in each of the apertures of said main body, said hollow inserts extending radially outwardly from the outer surface of said main body a distance greater than the depth of the apertures, and a plurality of elongate members extending radially outwardly from said main body, said elongate members including a proximal end and a distal end, the proximal ends of said elongate members received within respective ones of said hollow inserts.

The present invention also contemplates a method for making the artificial reef.

Finally, the present invention additionally contemplates a method for attracting fish. The method comprises providing a main body of spherical shape provided with a plurality of apertures, snuggly disposing a plurality of hollow inserts in each of the apertures of said main body, said inserts extending radially outwardly from the outer surface of said main body a distance greater than the depth of the apertures, positioning the proximal ends of a plurality of elongate members in respective ones of said hollow inserts, thereby causing the distal ends of said elongate members to extend radially outwardly from said main body, and placing the assembly of said main body, inserts, and elongate members into a body of water.

### BRIEF DESCRIPTION OF THE DRAWINGS

The above as well as other objects and advantages of the invention will become readily apparent to those skilled in the art from reading the following detailed description of a preferred embodiment of the invention when considered in the light of the attached drawings, in which:

FIG. 1 is a perspective view of an assembled artificial reef incorporating the features of the invention;

FIG. 2 is an elevational view of the main body of an artificial reef embodying the features of the present invention; and

FIG. 3 is an elevational view of the main body illustrated in FIG. 1 showing radially outwardly extending cylindrical inserts.

### DETAILED DESCRIPTION OF THE PREFERRED EMBODIMENT

Referring to the drawings, there is illustrated an artificial reef embodying the features of the present invention. More particularly, there is illustrated a main body 10 having an inner member 12 and an outer peripheral surface 14. Aligned apertures 16 are formed to extend inwardly through the outer surface 14 and terminating short of the center of inner member 12.

A plurality of hollow, cylindrical inserts 18 are inserted into respective apertures 16. It will be appreciated that only a single insert 18 is received within each of the apertures 16. The hollow inserts 18 extend radially outwardly from the outer surface 14 of the main body 10 a distance greater than the depth of the apertures 16. This is to give additional support and rigidity to the elongate members 20 as compared to merely inserting the elongate members 20 directly into the apertures 16.

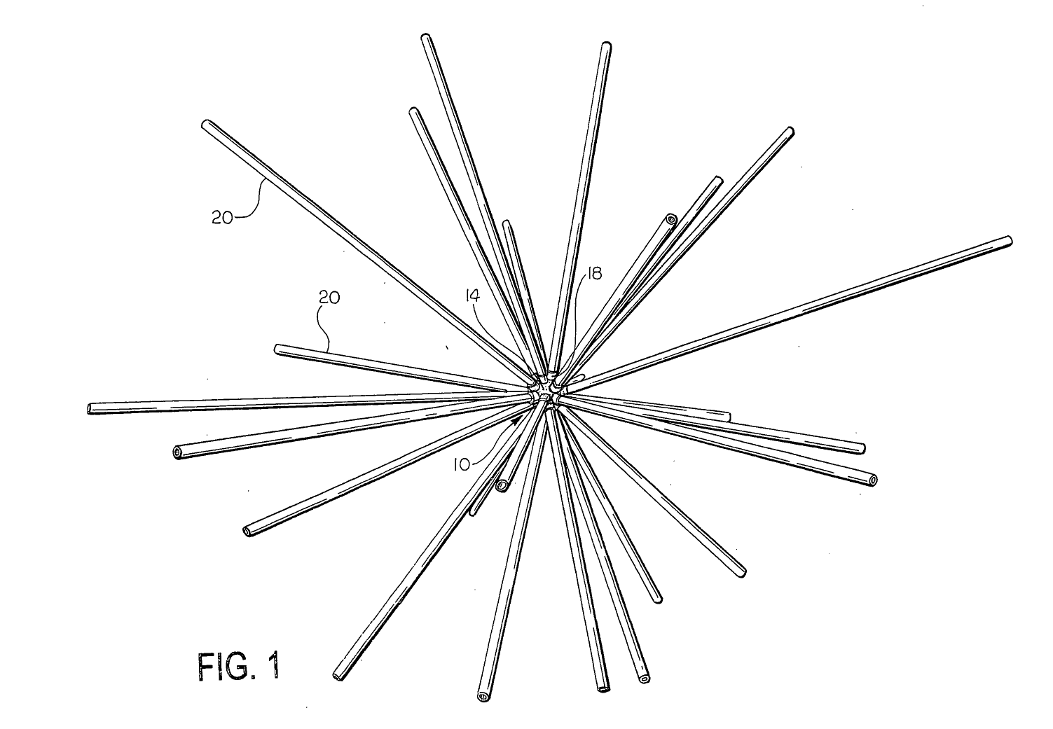

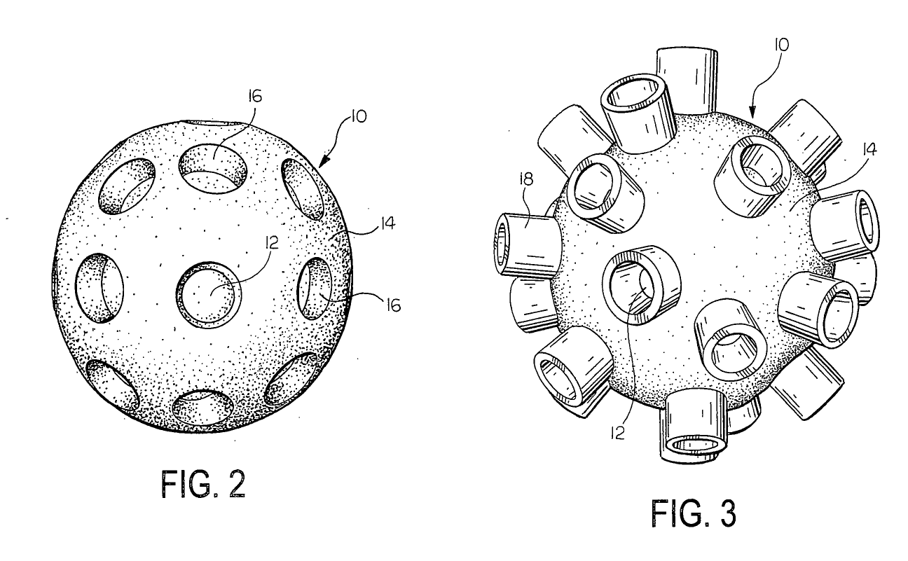

Each of the hollow inserts 18 receives the proximal end of one of a plurality of elongate members 20, such as tubes. In the assembled form, as illustrated in FIG. 1, the distal ends of the elongate members 20 are disposed at spaced relation away from the outer surface of the main body 10. In a preferred embodiment of the invention, fifteen of the elongate members 20 are of a length of approximately 36 inches, and eleven of the elongate members 20 are of a length of approximately 46 inches.

In a preferred embodiment of the invention, the main body 10 is spherical in shape, and is typically formed of a plastic such as for example a polyvinylchloride resin. It will be understood, however, that other shapes and polymers and copolymers may be utilized for the main body 10, hollow inserts 18, and elongate members 20 without departing from the spirit of the invention.

In accordance with the provisions of the patent statutes, the present invention has been described in what is considered to represent its preferred embodiment. However, it should be understood that the invention can be practiced otherwise than as specifically illustrated and described without departing from its spirit or scope.

1. An artificial reef for attracting fish, comprising:
a main body of spherical shape provided with a plurality of apertures;
a plurality of hollow inserts snuggly disposed in each of the apertures of said main body, said inserts extending radially outwardly from the outer surface of said main body a distance greater than the depth of the apertures; and
a plurality of elongate members extending radially outwardly from said main body, said elongate members including a proximal end and a distal end, the proximal ends of said elongate members received within respective ones of said hollow inserts.

2. The artificial reef according to claim 1, wherein the main body is formed of a plastic material.

3. The artificial reef according to claim 2, wherein the plastic is polyvinyl chloride.

4. The artificial reef according to claim 1, wherein the elongate members are hollow tubes.

5. The artificial reef according to claim 1, wherein the elongate members are formed of a plastic material.

6. The artificial reef according to claim 5, wherein the plastic is polyvinyl chloride.

7. The artificial reef according to claim 1, wherein some elongate members have different lengths.

8. A method of making an artificial reef for attracting fish, comprising the steps of:
providing a main body of spherical shape provided with a plurality of apertures;
snuggly disposing a plurality of hollow inserts in each of the apertures of said main body, said inserts extending radially outwardly from the outer surface of said main body a distance greater than the depth of the apertures; and
positioning the proximal ends of a plurality of elongate members in respective ones of said hollow inserts, thereby causing the distal ends of said elongate members to extend radially outwardly from said main body.

9. The artificial reef according to claim 8, wherein the main body is formed of a plastic material.

10. The artificial reef according to claim 9, wherein the plastic is polyvinyl chloride.

11. The artificial reef according to claim 8, wherein the elongate members are hollow tubes.

12. The artificial reef according to claim 8, wherein the elongate members are formed of a plastic material.

13. The artificial reef according to claim 12, wherein the plastic is polyvinyl chloride.

14. The artificial reef according to claim 8, wherein some elongate members have different lengths.

15. A method of attracting fish, comprising the steps of:
providing a main body of spherical shape provided with a plurality of apertures;
snuggly disposing a plurality of hollow inserts in each of the apertures of said main body, said inserts extending radially outwardly from the outer surface of said main body a distance greater than the depth of the apertures;
positioning the proximal ends of a plurality of elongate members in respective ones of said hollow inserts, thereby causing the distal ends of said elongate members to extend radially outwardly from said main body; and
placing the assembly of said main body, hollow inserts, and elongate members into a body of water.

16. The artificial reef according to claim 15, wherein the main body is formed of a plastic material.

17. The artificial reef according to claim 16, wherein the plastic is polyvinyl chloride.

18. The artificial reef according to claim 15, wherein the elongate members are hollow tubes.

19. The artificial reef according to claim 15, wherein the elongate members are formed of a plastic material.

20. The artificial reef according to claim 19, wherein the plastic is polyvinyl chloride.

21. The artificial reef according to claim 15, wherein some elongate members have different lengths.
